(19) United States
(12) Patent Application Publication
(10) Pub. No.: US 2016/0114677 A1
(43) Pub. Date: Apr. 28, 2016

(54) MOTOR-GEAR UNIT AS WELL AS WHEEL-HUB DRIVE HAVING SUCH A MOTOR-GEAR UNIT

(71) Applicant: ROBERT BOSCH GMBH, Stuttgart (DE)

(72) Inventor: Ralph ENGELBERG, Ditzingen (DE)

(73) Assignee: Robert Bosch GmbH, Stuttgart (DE)

(21) Appl. No.: 14/787,194

(22) PCT Filed: Mar. 3, 2014
(86) PCT No.: PCT/EP2014/054066

§ 371 Date: Oct. 26, 2015

(30) Foreign Application Priority Data
Apr. 26, 2013 (DE) 10 2013 207 681.9

(51) Int. Cl. B60K 17/14; B60K 17/04; F16H 3/00; B60K 17/26; B62M 6/60; B62M 11/04; B60K 7/00; B60K 17/06

(52) U.S. Cl. CPC B60K 17/145; B60K 7/0007; B60K 17/043; B60K 17/06; B60K 17/26; B62M 6/60; B62M 11/04; F16H 3/003

(57) ABSTRACT

A motor-gear unit is provided, including a motor, preferably an electric motor, having a first and second drive direction, a gear unit which is situated directly on the motor and includes an input shaft and a driven shaft as well as a controller, which is set up to drive the motor in the first and second drive direction, the gear unit having a first gear stage and a second gear stage, which feature different gear ratios, the first gear stage having a first freewheel and the second gear stage having a second freewheel, and a freewheel direction and a blocking direction of the first freewheel and the second freewheel are different.

### FIELD OF THE INVENTION

The present invention relates to a compact motor-gear unit, in which a gear unit is situated directly on a motor, such as an electric motor. In the following text reference is always made to electric motors, although the present invention is not restricted to such motors. In addition, the present invention relates to a wheel-hub drive including a motor-gear unit of this type, and to a vehicle, in particular an electric bike having such a wheel-hub drive.

### BACKGROUND INFORMATION

Compact motor-gear units, which are also referred to as geared motors, are known from the related art. Here, a gear unit which is situated directly on the electric motor reduces an output rotational speed in order to increase in particular an output torque of the electric motor. In addition, wheel-hub drives are known, for instance in connection with electric bicycles, which are installed in a wheel hub. However, one problem of such wheel-hub drives in electric bicycles is their relatively large size.

### SUMMARY

In contrast, the motor-gear unit according to the present invention has the advantage that the electric motor of the motor-gear unit is able to be operated efficiently in the largest possible rpm band. In the present invention, this is achieved in that the electric motor can be operated in two directions by reversing the direction of rotation, a first gear ratio being provided in a first direction of rotation, and a second gear ratio, which differs from the first gear ratio, being provided in a second direction of rotation. Two gear stages are therefore available, a first gear stage, which has a first freewheel, being provided in a first direction of rotation, and the second gear stage, which has a second freewheel, being provided in a second direction of rotation that runs counter to the first direction. Depending on the direction of rotation of the electric motor, only one of the two gear stages is consequently active in each case, while the other is inactive via the freewheel. By reversing the direction of rotation, the motor-gear unit according to the present invention may have two different gear stages, despite the very simple and compact design of the motor-gear unit. Because of the two freewheels, each blocking or releasing in a different direction, only one gear stage becomes active, depending on the direction of rotation, so that a favorable gear ratio range is able to be selected as a function of the rotational speed of the electric motor. No actuators or similar devices are required for changing the gear ratio; instead, the electric motor is able to be controlled simply by a modified actuation, i.e., its direction of rotation, in order to allow a change in the rotational speed. The change in the direction of rotation is easily specifiable by a controller.

The first and second gear stages preferably have a shared input shaft and a shared driven shaft. This results in an especially compact construction. Gear wheels preferably are disposed on the input shaft and the driven shaft in both of the two gear stages. The electric motor is especially preferably set up in such a way that the input shaft of the gear unit is driven directly. In other words, a driven shaft of the electric motor is identical with the input shaft of the gear unit.

The first gear stage especially preferably includes a first and a second gear wheel, and the second gear stage includes a third and a fourth gear wheel. The first and third gear wheels are situated on the input shaft, and the second and fourth gear wheels are disposed on the driven shaft.

In order to obtain the same direction of rotation at the driven shaft, one of the two gear stages preferably has an even number of gear wheels and the other one of the two gear stages has an uneven number of gear wheels. This achieves a reversal of the direction of rotation again in the gear stage having the uneven number of gear wheels in an effort to obtain the same direction of rotation at the driven shaft. One of the two gear stages especially preferably includes precisely two gear wheels, and the other one of the two gear stages includes exactly three gear wheels.

To further reduce a rotational speed at the driven shaft, the motor gear unit preferably also includes a reduction gear mechanism, which is situated between the electric motor and the gear unit, in particular. According to one preferred further development of the present invention, the gear unit also includes a driven element, which is situated on the drive shaft. The driven element especially preferably is a driven gear wheel, which meshes with another gear wheel, especially a ring gear.

For a simple and cost-effective design, the two gear stages are especially preferably developed as spur gear units.

In addition, the present invention relates to a wheel-hub drive, which includes a hub and a motor-gear unit according to the present invention. The wheel-hub drive especially preferably includes a driven element, which is situated on the output shaft of the gear unit and drives the hub directly. The hub preferably has an internal toothing, which is in engagement with the driven element, preferably developed as a driven gear wheel, in order to drive the hub. It is especially preferred that the entire motor-gear unit is situated in the hub, which makes it possible to achieve a particularly compact construction. The hub also shields the motor-gear unit from soil and damage and the like.

One characteristic of the wheel-hub drive preferably is that the second gear wheel and the fourth gear wheel are developed as ring gears inside the hub and the hub simultaneously also represents the function of the driven shaft.

Moreover, the present invention relates to a vehicle having an inventive wheel-hub drive and/or an inventive motor-gear unit. The vehicle especially preferably is an electric bicycle. The wheel-hub drive preferably is situated on a rear wheel or front wheel of the electric bicycle. Moreover, the electric vehicle preferably is an E-scooter or a small commercial transport vehicle that benefits from a second gear, in particular. Moreover, the electric vehicle according to the present invention preferably is equipped with a recuperation device.

### BRIEF DESCRIPTION OF THE DRAWINGS

FIG. 1 shows a schematic view of an electric bicycle according to a first exemplary embodiment of the present invention.

FIG. 2 shows a schematic sectional view of a wheel-hub system of the electric bicycle from FIG. 1.

FIG. 3 shows a diagram, which illustrates the transmission ratios of the motor-gear unit from FIG. 2.

FIG. 4 shows a schematic perspective illustration of a motor-gear unit according to a second exemplary embodiment of the present invention.

FIG. 5 shows a diagram, which illustrates the transmission ratios of the motor-gear unit from FIG. 4.

FIGS. 6 to 9 show motor-gear units according to a third, fourth, fifth and sixth exemplary embodiment.

### DETAILED DESCRIPTION

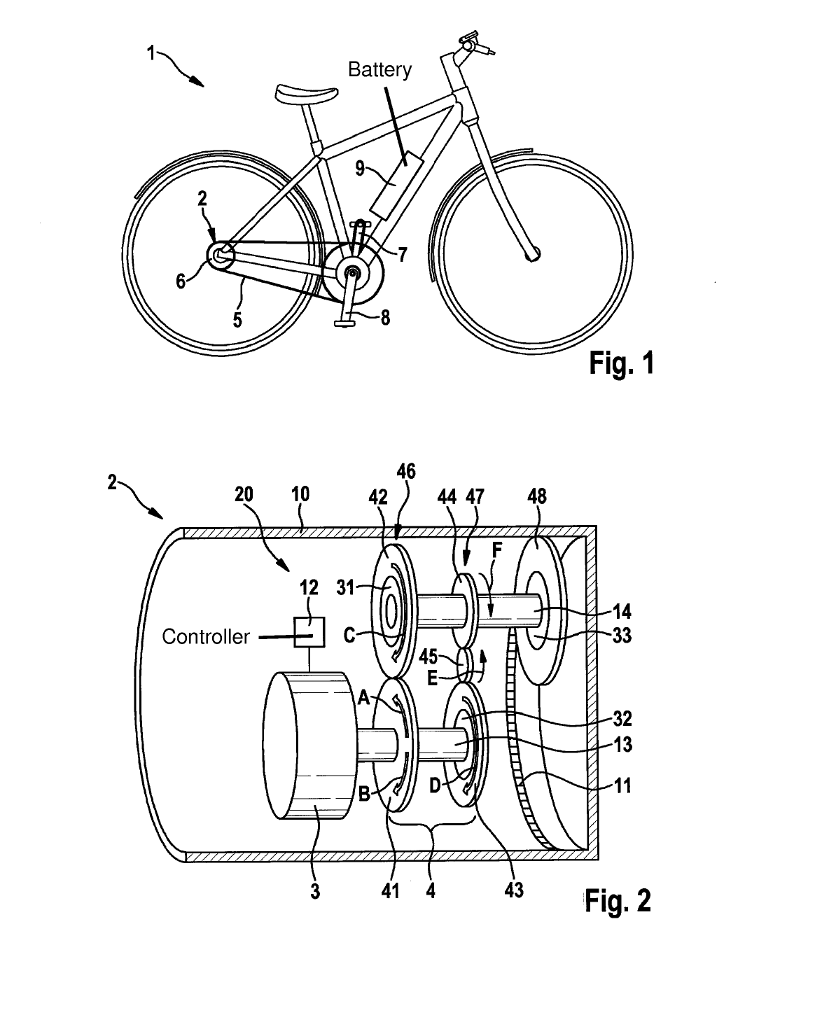

An electric bicycle 1 having a motor-gear unit 20 according to the present invention is described in detail below, with reference to FIGS. 1 to 3. As is clear from FIG. 1, electric bicycle 1 includes a wheel-hub drive 2, which is connected to a battery 9. Via cranks 7, 8, a bicycle is able to drive a chain 5, which can output a torque to the rear wheel via a pinion 6 on the rear wheel.

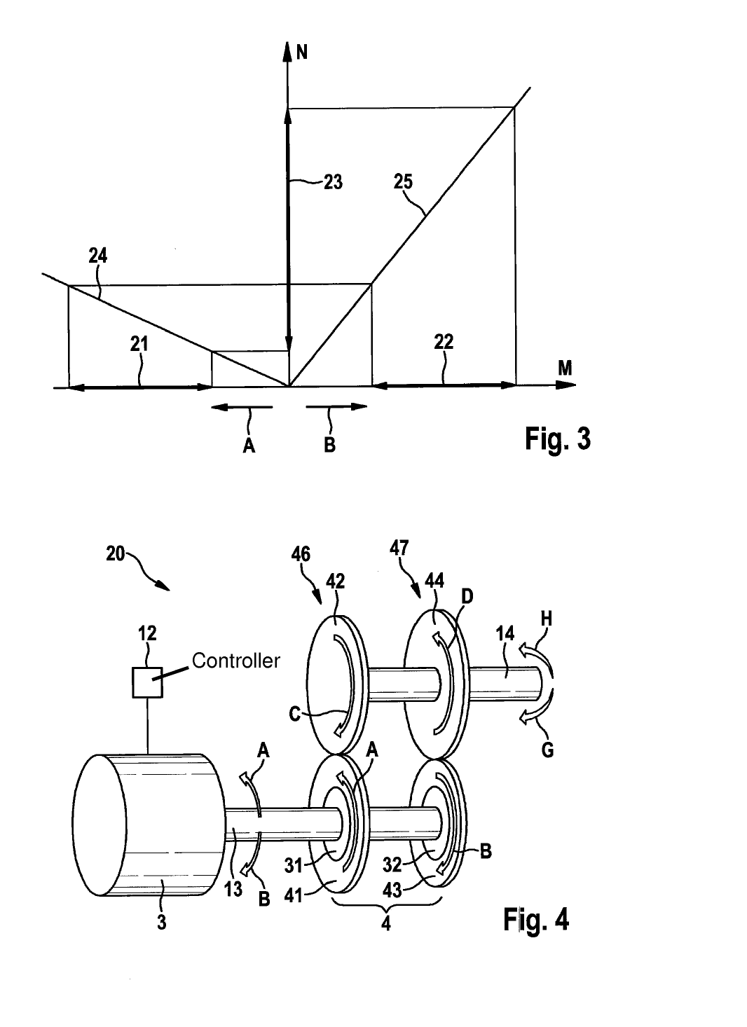

Wheel-hub drive 2 is shown in detail in FIG. 2. Wheel-hub drive 2 includes a wheel hub 10 and motor-gear unit 20. Motor-gear unit 20 encompasses an electric motor 3 and a gear unit 4. Gear unit 4 has a first gear stage 46 and a second gear stage 47.

First gear stage 46 includes a first gear wheel 41, which is disposed on an input shaft 13 of gear unit 4, and a second gear wheel 42, which is disposed on a driven shaft 14 of the gear unit. In addition, a first freewheel 31 is situated at second gear wheel 42. First freewheel 31 ensures that second gear wheel 42 is carried along in one direction of rotation and spins freely in the other direction.

Second gear stage 47 encompasses a third gear wheel 43, a fourth gear wheel 44, and a fifth gear wheel 45. Fifth gear wheel 45 is situated between the third and fourth gear wheel. Second gear stage 47 furthermore includes a second freewheel 32, which is disposed on third gear wheel 43. Second freewheel 32 ensures that third gear wheel 43 is rotating along in one direction of rotation and spins freely in the other direction, the freewheeling direction or the blocking direction being in exact opposition to that of first freewheel 31 in relation to input shaft 13 of second freewheel 32.

As can furthermore be gathered from FIG. 2, electric motor 3 is likewise situated on input shaft 13 of gear unit 4. In other words, a driven shaft of electric motor 3 is identical with input shaft 13 of the gear unit. Electric motor 3 is actuated with the aid of a controller 12, the latter being set up to induce a reversal of the direction of rotation of the electric motor. Electric motor 3 may include a gear unit for adapting the rotational speed.

In addition, a driven gear wheel 48 is situated on driven shaft 14, which is in engagement with an internal gearing 11 on sleeve 10. Sleeve 10 with internal gearing 11 thus constitutes a ring gear, which meshes with output gear wheel 48. Wheel hub 10, and through it, the rear wheel of the electric bicycle, are therefore driven via internal gearing 11.

If electric motor 3 is driven in a first direction of rotation A, first gear wheel 41 rotates in the same direction of rotation A. Accordingly, second gear wheel 42 rotates in the direction of arrow C, so that driven shaft 14 rotates in the same direction. In so doing, first freewheel 31 blocks in the direction of rotation C, which therefore allows a rotational speed transmission to driven shaft 14 via first gear stage 46. Second freewheel 32 is configured in such a way that third gear wheel 43 does not rotate along and second gear stage 47 thus is not active.

If controller 12 implements a reversal in the direction of rotation on electric motor 3, first gear wheel 41 rotates in the direction of arrow B, but no rotational speed is transmitted via second gear wheel 42, since first freewheel 31 prevents a transmission of rotational speed to driven shaft 14 via first gear stage 46. In contrast, third gear wheel 43 rotates in the direction of arrow D, since second freewheel 32 blocks third gear wheel 43 in the second direction of rotation B. Accordingly, fifth gear wheel 45 rotates in the direction of arrow E, and fourth gear wheel 44 in the direction of arrow F. As a consequence, the same direction of rotation as in a transmission of the rotational speed via first gear stage 46 is present again at driven shaft 14.

Depending on the direction of rotation of electric motor 3, the rotational speed thus is transmitted to driven shaft 14 only via first gear stage 46 or only via second gear stage 47. Situated on driven gear wheel 48 is a third freewheel 33, which enables the rotational speed to be transmitted in the direction of rotation (C, F) of driven shaft 14 driven via electric motor 3, but will not allow such a transmission in the opposite direction. Third freewheel 33 operates as a normal freewheel on the electric bicycle.

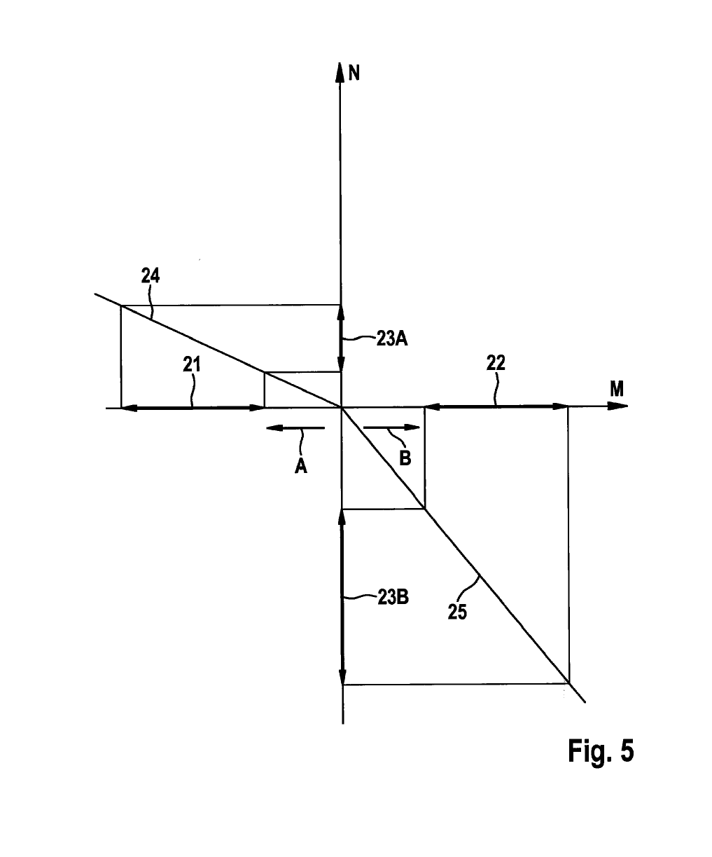

The diagram of FIG. 3 shows a rotational speed N of driven shaft 14 over a rotational speed M of electric motor 3. In a first direction of rotation A (left part of the diagram of FIG. 3), which features first transmission ratio 24 of first gear stage 46, a first rotational speed range 21 is obtained. If electric motor 3 is driven in the second direction of rotation B (right portion of the diagram from FIG. 3), a second rotational speed range 22 comes about. A corresponding rotational speed range at driven shaft 14 is realized via second transmission ratio 25 of second gear stage 47. Reference numeral 23 in FIG. 3 denotes the complete rotational speed range at driven shaft 14 that is obtained via the two transmission ratios 24, 25. It is clear from the diagram from FIG. 3 that in the present invention a reversal of the direction of rotation of the electric motor therefore makes it possible to obtain a considerably greater rotational speed range 23 at driven shaft 14 than would be possible in a gear unit having only a single stage.

A compact and effective wheel-hub drive 2 thus is able to be provided according to the present invention, which is disposed inside wheel hub 10 in its entirety. It should be noted that controller 12 need not necessarily be placed in wheel hub 10, but may also be situated at some other location of the bicycle.

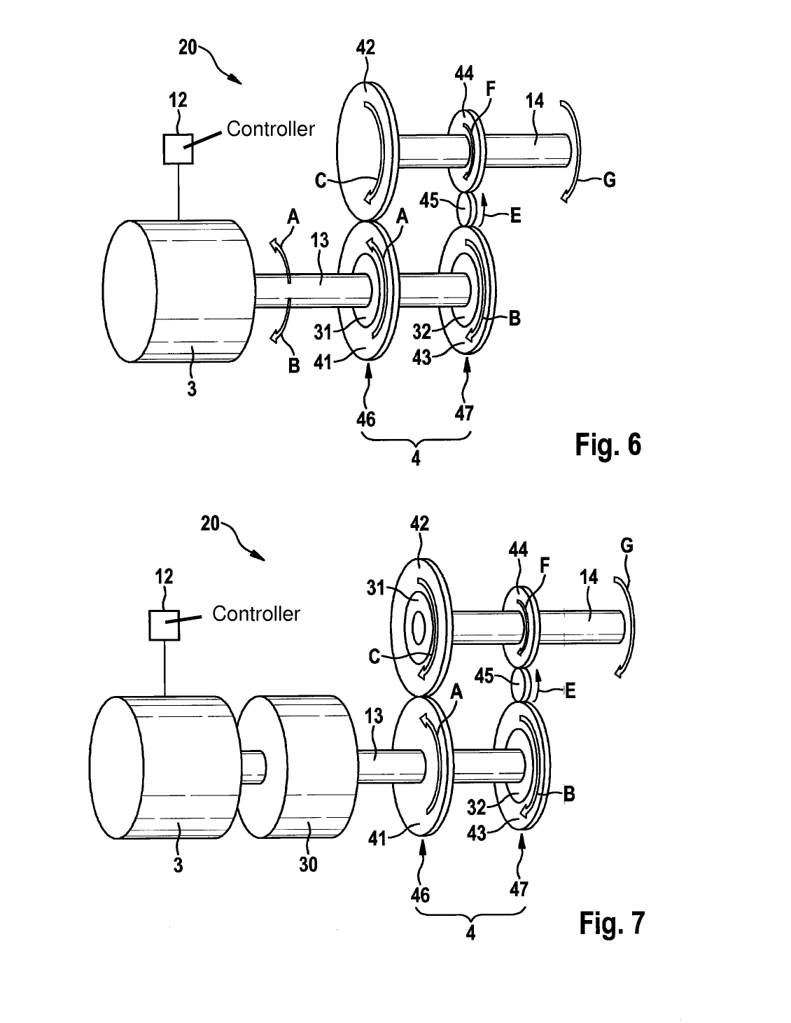

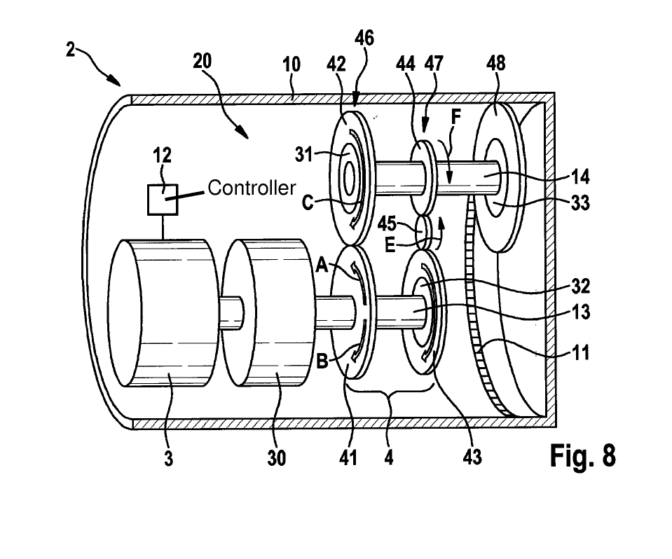

A motor-gear unit 20 according to a second exemplary embodiment of the present invention is described in detail in FIGS. 4 and 5. In contrast to the first exemplary embodiment, first gear stage 46 and second gear stage 47 in the second exemplary embodiment are developed in such a way that output shaft 14 rotates in a first direction of rotation G when the rotational speed of electric motor 3 is transmitted via first gear stage 46, while it rotates in a second direction of rotation H when the rotational speed is transmitted via second gear stage 47. As can be gathered from FIG. 4, each of the two gear stages 46, 47 is provided with exactly two gear wheels. As a result, no additional reversal of the direction of rotation by an additional gear wheel as in the first exemplary embodiment takes place in any of the two gear stages. First freewheel 31 is disposed on first gear wheel 41, and second freewheel 32 is situated on third gear wheel 43.

The diagram from FIG. 5 shows rotational speed N of driven shaft 14 over a rotational speed M of electric motor 3. Since no additional gear wheel is situated in the second gear unit in the second exemplary embodiment, the direction of rotation of driven shaft 14 changes in response to a change in direction of electric motor 3. This makes it possible to realize an electric drive which has a forward gear and a reverse gear. In the first direction of rotation, first transmission ratio 24 supplies a first rotational speed range 23A across first engine speed range 21 at the driven shaft in first direction of rotation G. In a reversal of the direction of rotation of electric motor 3, second transmission ratio 25 supplies a second rotational speed range 23B at driven shaft 14 in the opposite direction of rotation H in a second rotational speed range 22 of the drive.

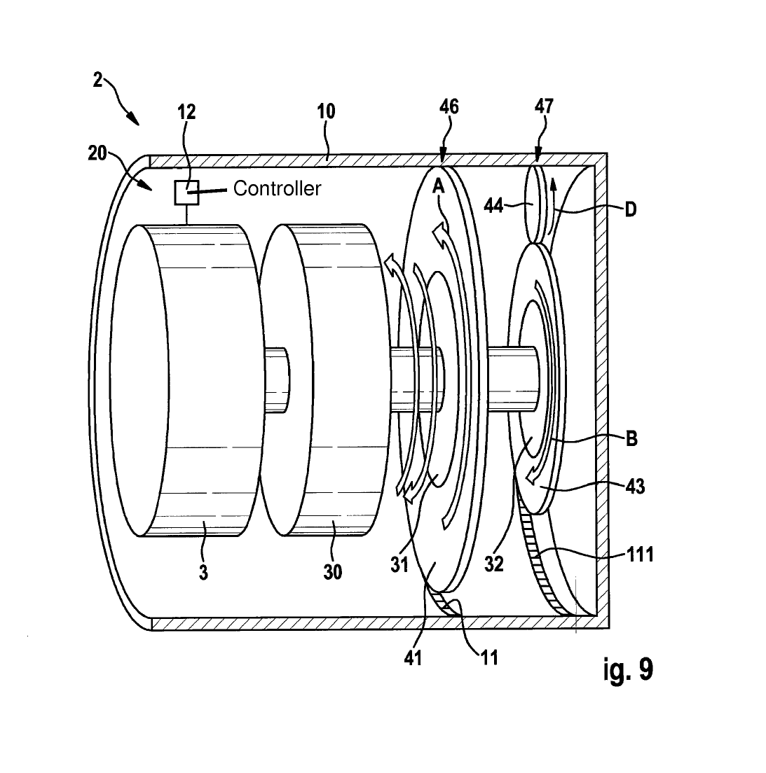

FIG. 6 shows a motor-gear unit 20 according to a third exemplary embodiment of the present invention, which essentially corresponds to the second exemplary embodiment. In contrast to the second exemplary embodiment, a fifth gear wheel 45 is additionally provided in second gear stage 47 in the third exemplary embodiment, similar to the first exemplary embodiment, so that a reversal in the direction of rotation is obtained in second gear stage 47. Regardless of the choice of the direction of rotation, this results in an identical output direction of rotation G at driven shaft 14 on electric motor 3.

The fourth exemplary embodiment shown in FIG. 7 essentially corresponds to the third exemplary embodiment, but in contrast thereto, a reduction gear 30 is provided in addition. Reduction gear 30 is situated between electric motor 3 and gear unit 4 and adapts the output rotational speed of electric motor 3 to the particular requirement of the application before it enters gear unit 4. For example, the rotational speed level may be reduced in order to achieve higher torques.

FIG. 8 shows a wheel-hub drive 2 having a motor-gear unit 20 according to a fifth exemplary embodiment of the present invention. The fifth exemplary embodiment essentially corresponds to the fourth exemplary embodiment, but in addition to reduction gear 30, a driven gear wheel 48 is situated at driven shaft 14 as well. Driven gear wheel 48 is in engagement with internal gearing 11 on wheel hub 10 in order to rotate wheel hub 10. Gear wheels 48 and 47 may also be combined in one component.

FIG. 9 shows a motor-gear unit 2 according to a sixth exemplary embodiment of the present invention, which essentially corresponds to the exemplary embodiment shown in FIG. 8. However, no shared driven shaft is provided in the sixth exemplary embodiment; instead, first gear wheel 41 meshes with a first internal gearing 11 of wheel hub 10, and gear wheel 44 of second gear stage 47 meshes with a second internal gearing 111 of wheel hub 10. In this exemplary embodiment, wheel hub 10 is therefore driven directly as well. In this exemplary embodiment, first gear stage 46 consequently includes only first gear wheel 41. It should be noted, however, that it is naturally possible to provide still further gear wheels for a further translation. By providing the two freewheels 31, 32, wheel hub 10 rotates in the same direction in each case, regardless of a direction of rotation of electric motor 3. This design is therefore even more compact and has a minimum number of components, which makes it easy to integrate control unit 12 into the hub as well.

As can be gathered from the afore-described exemplary embodiments, the present invention is therefore able to provide a compact motor-gear unit 20, which can be placed in a wheel hub 10, in particular. Rotational speeds are transmitted via a first gear stage 46 or a second gear stage 47 of gear unit 4, as a function of the direction of rotation of the electric motor. Depending on the development of the gear stages, an output shaft 14 may have only a single direction of rotation G in both directions of rotation of the electric motor, or, as an alternative, output shaft 14 has two different directions of rotations G, H, as described in the second exemplary embodiment. Motor-gear unit 20 according to the present invention has only a minimum number of components and is very compact and robust. An output may occur as desired via output shaft 14 or via an output element disposed on the output shaft, e.g., to output gear wheel 48 or directly to wheel hub 10. With the aid of the present invention, it is therefore possible to realize applications in a larger rotational speed band, and electric motor 3 is able to be operated in an efficient manner in an optimal operating range. Apart from the use in electric bicycles in wheel-hub drives, motor-gear unit 20 according to the present invention may also be used in hybrid vehicles or electric vehicles, for example.

1.-13. (canceled)

14. An electric vehicle, comprising:
a wheel hub drive having a wheel hub and a motor-gear unit, the motor-gear unit having:
an electric motor capable of operating in a first drive direction and a second drive direction,
a gear unit disposed directly on the electric motor and having an input shaft and a driven shaft, and
a controller for driving the electric motor in the first and second drive directions, wherein:
the gear unit includes a first gear stage and a second gear stage that have different translation ratios,
the first gear stage includes a first freewheel,
the second gear stage includes a second freewheel,
a freewheeling direction and a blocking direction of the first freewheel and the second freewheel are different,
the gear unit includes an output element situated on the driven shaft, and
the output element of the gear unit drives the wheel hub directly.

15. The electric vehicle as recited in claim 14, wherein the electric vehicle includes one of an electric bicycle, an E-scooter, and a small pick-up truck.

16. The electric vehicle as recited in claim 14, wherein the first and second gear stages have a shared input shaft and a shared driven shaft.

17. The electric vehicle as recited in claim 16, wherein the input shaft of the gear unit is an output shaft of the electric motor.

18. The electric vehicle as recited in claim 14, wherein:
the first gear stage includes a first gear wheel and a second gear wheel,
the second gear stage includes a third gear wheel and a fourth gear wheel,
the first and the third gear wheels are disposed on the input shaft, and
the second and fourth gear wheels are disposed on the driven shaft.

19. The electric vehicle as recited in claim 18, wherein:
the first freewheel is situated on the first gear wheel, and the second freewheel is situated on the third gear wheel, or
the first freewheel is situated on the second gear wheel, and the second freewheel is situated on the third gear wheel, or
the first freewheel is situated on the first gear wheel, and the second freewheel is situated on the fourth gear wheel, or
the first freewheel is situated on the second gear wheel, and the second freewheel is situated on the fourth gear wheel.

20. The electric vehicle as recited in claim 14, wherein one of the two gear stages has an even number of gear wheels, and the other one of the two gear stages has an odd number of gear wheels, the odd number of gear wheels being used for reversing the direction of rotation.

21. The electric vehicle as recited in claim 14, further comprising a reduction gear situated between the electric motor and the gear unit.

22. The electric vehicle as recited in claim 14, wherein the wheel hub has an internal gearing that is in engagement with the output element.

23. The electric vehicle as recited in claim 14, wherein the second gear wheel and the fourth gear wheel are ring gears in the hub, and wherein the hub simultaneously represents a function of the driven shaft.
